(19) United States
(12) Patent Application Publication
(10) Pub. No.: US 2011/0196063 A1
(43) Pub. Date: Aug. 11, 2011

(54) RUBBER COMPOSITION FOR TREAD AND TIRE USING THE RUBBER COMPOSITION

(75) Inventor: Daigo Yonemoto, Higashiyamato-shi (JP)

(73) Assignee: BRIDGESTONE CORPORATION, Chuo-ku, Tokyo (JP)

(21) Appl. No.: 13/123,099

(22) PCT Filed: Sep. 1, 2009
(86) PCT No.: PCT/JP2009/065258

§ 371 Date: Apr. 7, 2011

(30) Foreign Application Priority Data
Oct. 8, 2008 (JP) 2008-262014
Oct. 8, 2008 (JP) 2008-262107

(51) Int. Cl. C08J 5/14; C08L 7/00; C08L 15/00; C08K 3/04

(52) U.S. Cl. 523/156; 523/155

(57) ABSTRACT

The present invention relates to a rubber composition for tread which is capable of improving wear resistance and tear resistance and reducing rolling resistance in a compatible manner. Specifically, the present invention relates to a rubber composition for tread, produced by blending carbon black with rubber components including modified conjugated diene-based polymer having at least one nitrogen-containing functional group, wherein the carbon black is obtained by a specific process and light transmittance of toluene extract thereof observed at the multi-stage rapid cooling medium introduction means satisfies relationships of formula (I) and formula (II) below.

10<X<40 (I)

90<Z<100 (II)

In the formulae, X represents light transmittance of toluene extract (%) of carbon black after the first rapid cooling medium, counted from the raw material introduction position, is introduced, and Z represents light transmittance of toluene extract (%) of carbon black after the last rapid cooling medium, counted from the raw material introduction position, is introduced.

### TECHNICAL FIELD

The present invention relates to a rubber composition for tread and a tire using the rubber composition for tread. In particular, the present invention relates to a rubber composition for tread which is capable of improving durability such as wear resistance and tear resistance and reducing rolling resistance in a compatible manner.

### PRIOR ART

Due to the social demands for saving energy and natural resources in recent years, there has been a need for tires having relatively low rolling resistance in order to save fuel consumption of automobiles. Examples of the known techniques for reducing rolling resistance to meet such a request as described above include a method of lowering hysteresis loss of a rubber composition by reducing an amount of carbon black used therein and/or using low-grade carbon black; and using the rubber composition in a tire ember, in particular, a tread rubber. However, simply reducing an amount of carbon black used in a rubber composition may deteriorate wear resistance of the rubber composition. In an alternative case where rolling resistance of a tire is reduced or improved by increasing the proportion of polybutadiene rubber in rubber components of a rubber composition and/or making the rubber composition highly elastic, there arises a problem that tear resistance of the rubber composition may deteriorate.

JP 2005-041975 discloses a rubber composition capable of improving both wear resistance and rolling resistance of a tire in a compatible manner by improving dispersion properties of carbon black by using terminal-modified polymer such as terminal-modified polybutadiene rubber.

### DISCLOSURE OF THE INVENTION

### Problems to be Solved by the Invention

According to the rubber composition disclosed in JP 2005-041975, hysteresis loss of terminal-modified polybutadiene is lowered and there is obtained an effect of making wear resistance and rolling resistance compatible to some degree. However, in JP 2005-041975 there is still room for improvement regarding these two performances, i.e. wear resistance and rolling resistance.

An object of the present invention is to solve the prior art problems described above and provide a rubber composition for tread which is capable of improving durability such as wear resistance and tear resistance and reducing rolling resistance in a compatible manner. Further, another object of the present invention is to provide a tire using the rubber composition for tread, in which wear resistance, tear resistance and rolling resistance are improved in a highly balanced manner.

### Means for Solving the Problems

As a result of a keen study to achieve the aforementioned objects, the inventors of the present invention has discovered that durability and rolling resistance of a tire can be improved in a compatible manner by using in a tread of the tire a rubber composition obtained by blending carbon black having a relatively small amount of tar components (polycyclic aromatic hydrocarbons, in particular) on surfaces thereof with rubber components including modified conjugated diene-based polymer having nitrogen-containing functional group(s), thereby completing the present invention.

Specifically, the rubber composition for tread according to the present invention is a rubber composition for tread, obtained by blending carbon black with rubber components including modified conjugated diene-based polymer having at least one nitrogen-containing functional group, characterized in that the carbon black is obtained by: preparing a reaction apparatus having a combustion gas generation zone, a reaction zone, and a reaction cease zone provided in series; generating a high temperature combustion gas in the combustion gas generation zone of the reaction apparatus; introducing a raw material into the reaction zone to form a reaction gas flow containing carbon black; and then rapidly cooling the reaction gas flow in the reaction cease zone by multi-stage rapid cooling medium introduction means to terminate the reaction, wherein light transmittance of toluene extract observed at the multi-stage rapid cooling medium introduction means satisfies relationships of formula (I) and formula (II) below.

10<X<40 (I)

90<Z<100 (II)

In the formulae, X represents light transmittance of toluene extract (%) of carbon black after the first rapid cooling medium, counted from the raw material introduction position, is introduced, and Z represents light transmittance of toluene extract (%) of carbon black after the last rapid cooling medium, counted from the raw material introduction position, is introduced.
The light transmittance of toluene extract of carbon black after the last rapid cooling medium, counted from the raw material introduction position, is introduced is synonymous with the light transmittance of toluene extract of carbon black after the production process is completed.

In a preferable example of the rubber composition for tread of the present invention, the rubber components further include natural rubber.

In another preferable example of the rubber composition for tread of the present invention, the carbon black has: dibutylphthalate (DBP) absorption in the range of 40 to 180 cm³/100 g; a specific surface area by nitrogen adsorption (N₂SA) in the range of 40 to 300 m²/g; tinting strength (TINT) in the range of 50 to 150%; and light transmittance of toluene extract of not lower than 90%, wherein the values of the specific surface area by nitrogen adsorption (N₂SA) and the light transmittance of toluene extract satisfy formula (III) below.

0.0283×A×(100−B)≦40 (III)

In the formula, A represents specific surface area by nitrogen adsorption (m²/g) and B represents light transmittance of toluene extract (%).

In yet another preferable example of the rubber composition for tread of the present invention, the content of the carbon black to be blended is less than 40 parts by mass with respect to 100 parts by mass of the rubber components and the content of silica to be blended is not larger than 20 parts by mass with respect to 100 parts by mass of the rubber components. In this example, low heat generation properties of the rubber composition are improved.

In yet another preferable example of the rubber composition for tread of the present invention, the rubber composition contains a silane coupling agent by 10 parts by mass or less with respect to silica. In this example, dispersion properties of silica improve, whereby the reinforcing effect caused by silica is enhanced.

In yet another preferable example of the rubber composition for tread of the present invention, the content of the carbon black blended in the rubber composition is at least 40 parts by mass with respect to 100 parts by mass of the rubber components.

In the rubber composition for tread of the present invention, preferable examples of the nitrogen-containing functional group of the modified conjugated diene-based polymer include substituted or unsubstituted amino group, amide group, imino group, imidazole group, nitrile group and pyridyl group. The nitrogen-containing functional group is more preferably a substituted amino group represented by formula (IV) below,

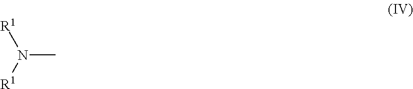

In the formula, R¹ each independently represents C₁₋₁₂ alkyl group, cycloalkyl group or aralykyl group) or a cyclic amino group represented by formula (V) below.

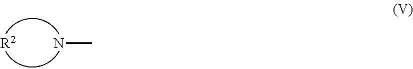

In the formula, R² represents one of alkylene group having 3 to 16 methylene groups, substituted alkylene group, oxyalkylene group and N-alkylamino-alkylene group. The nitrogen-containing functional group is further more preferably hexamethyleneimino group. The nitrogen-containing functional groups as described above exhibit a good filler-dispersion effect in a rubber composition in which various fillers such as carbon black, silica and the like are blended, thereby significantly enhancing the reinforcing effect caused by the fillers.

In yet another preferable example of the rubber composition for tread of the present invention, the conjugated diene-based polymer is polybutadiene rubber and preferably polybutadiene rubber having at least one hexamethyleneimino group.

In yet another preferable example of the rubber composition for tread of the present invention, the natural rubber is obtained from latex resulting from partial deproteinization of protein in natural rubber latex by mechanical separation techniques; and the total nitrogen content in the natural rubber is in the range of 0.1 mass % to 0.4 mass % (exclusive of 0.1 mass % and inclusive of 0.4 mass %). In this example, hysteresis loss of the rubber composition can be lowered with maintaining good durability of the rubber composition.

Further, a tire of the present invention is characterized in that the tire uses the aforementioned rubber composition for tread as tread rubber.

### Effect of the Invention

According to the present invention, a rubber composition for tread which is capable of reducing rolling resistance and enhancing durability such as wear resistance and tear resistance in a compatible manner can be provided by blending carbon black having a relatively small amount of tar components (polycyclic aromatic hydrocarbons, in particular) on surfaces thereof with rubber components including modified conjugated diene-based polymer having nitrogen-containing functional group(s). Further, according to the present invention, a tire using the rubber composition for tread can be provided in which wear resistance, tear resistance and rolling resistance are improved in a highly balanced manner.

### BRIEF DESCRIPTION OF THE DRAWING

FIG. 1 is a vertically sectional front explanatory view of one example of a carbon black production furnace for producing carbon black for use in a rubber composition of the present invention.

### BEST MODE FOR IMPLEMENTING THE PRESENT INVENTION

The present invention will be described in detail hereinafter. The rubber composition for tread according to the present invention is a rubber composition for tread, obtained by blending carbon black with rubber components including modified conjugated diene-based polymer having at least one nitrogen-containing functional group, wherein the carbon black is characteristically obtained by: preparing a reaction apparatus having a combustion gas generation zone, a reaction zone, and a reaction cease zone provided in series therein; generating a high temperature combustion gas in the combustion gas generation zone of the reaction apparatus; introducing a raw material into the reaction zone to form a reaction gas flow containing carbon black; and then rapidly cooling the reaction gas flow in the reaction cease zone by multi-stage rapid cooling medium introduction means to terminate the reaction, and light transmittance of toluene extract observed at the multi-stage rapid cooling medium introduction means satisfies relationships of the aforementioned formula (I) and formula (II).

In a rubber composition obtained by blending carbon black with rubber components including modified conjugated diene-based polymer having a nitrogen-containing functional group, dispersibility of carbon black with respect to the rubber components generally improves and thus hysteresis loss of the rubber components decreases, whereby wear resistance and rolling resistance can be improved in a compatible manner. However, the hysteresis loss-lowering effect need be further enhanced in a case where rubber components in use further include natural rubber blended with the modified conjugated diene-based polymer because natural rubber obtained by the conventional production method may contain remnants of non-rubber components contained in natural rubber latex and thus have relatively high loss tangent (tan δ) and exhibit a relatively poor heat generation reducing effect. In contrast, the carbon black for use in the rubber composition of the present invention, which is obtained by a specific process, has a sufficiently low amount of tar content present on surfaces thereof, whereby compositional reactions between carbon black and rubber molecules effectively occur and thus wear resistance and low heat generation properties of the rubber composition can be improved in a compatible manner. Further, in the rubber composition for tread of the present invention, dispersibility of carbon black is remarkably improved by using carbon black having a relatively small amount of tar components present on surfaces thereof and modified conjugated diene-based polymer having nitrogen-containing functional group(s) in combination, whereby it is possible to lower hysteresis loss in the rubber composition, while sufficiently ensuring the reinforcing effect of the carbon black. Accordingly, the rubber composition for tread of the present invention can remarkably improve wear resistance, tear resistance and rolling resistance of a tire in a compatible manner.

In the rubber composition for tread of the present invention, there is no particular restriction on the modified conjugated diene-based polymer for use as a rubber component, as long as the modified conjugated diene-based polymer has at least one nitrogen-containing functional group. The modified conjugated diene-based polymer may include other functional groups generally known to have compatibility with fillers like carbon black and silica, of which example include a silicon-containing functional group and a tin-containing functional group. In the present embodiment, the conjugated diene-based polymer is preferably copolymer of conjugated diene compound with aromatic vinyl compound or homopolymer of the conjugated diene compound, and specific examples thereof include natural rubber and synthetic rubber such as polyisoprene rubber (IR), styrene-butadiene copolymer rubber (SBR), polybutadiene rubber (BR), isobutyleneisoprene rubber (IIR), halogenated butyl rubber, styrene-isoprene copolymer rubber (SIR), chloroprene rubber (CR), and the like. Polybutadiene rubber is particularly preferable among these examples. In the rubber composition for tread of the present invention, wear resistance, tear resistance and rolling resistance of a tire can be sufficiently improved in a compatible manner in spite that natural rubber is blended with the modified conjugated diene-based polymer because the rubber composition for tread of the present invention exhibits a very good hysteresis loss-lowering effect. The conjugated diene-based polymers described above may be used either solely by one type or by two or more types in a blended state.

The conjugated diene-based polymer can be obtained by, for example, homopolymerization of conjugated diene compound as monomer or copolymerization of mixture of aromatic vinyl compound and conjugated diene compound as monomers. The rubber composition for tread of the present invention is preferably obtained, since it is necessary to introduce at least one nitrogen-containing functional group into molecules of the conjugated diene-based polymer, by (1) a method of polymerizing monomers by using a polymerization initiator to produce polymer having polymerization active sites and then modifying the polymerization active sites with a nitrogen-containing modifying agent of various types or (2) a method of polymerizing monomers by using a polymerization initiator having nitrogen-containing functional group(s).

The polymerization initiator for use in synthesis of the modified conjugated diene-based polymer is preferably an organic lithium compound and more preferably a hydrocarbyllithium compound or a lithiumamide compound. In a case an organic lithium compound is used as the polymerization initiator, aromatic vinyl compound and conjugated diene compound are polymerized by anion polymerization. In a case where hydrocarbyllithium is used as the polymerization initiator, there is obtained a polymer having a hydrocarbyl group at the polymerization initiation terminal and a polymerization active site at the other terminal. In a case here a lithiumamide compound is used as the polymerization initiator, there is obtained a polymer having a nitrogen-containing functional group at the polymerization initiation terminal and a polymerization active site at the other terminal, whereby the polymer can be used as the modified conjugated diene-based polymer without being modified with a nitrogen-containing modifying agent. The content of the polymerization initiator in use is preferably in the range of 0.2 to 20 mmol per 100 g of monomer.

Examples of hydrocarbyllithium described above include ethyllithium, n-propyllithium, isopropyllithium, n-butyllithium, sec-butyllithium, tert-octyllithium, n-decyllithium, phenyllithium, 2-naphthyllithium, 2-butyl-phenyllithium, 4-phenyl-butyllithium, cyclohexyllithium, cyclopentyllithium, a reaction product obtained by reacting diisopropenylbenzene with butyllithium, and the like. Among these examples, alkyllithium such as ethyllithium, n-propyllithium, isopropyllithium, n-butyllithium, sec-butyllithium, tert-octyllithium, n-decyllithium is preferable. N-butyllithium is particularly preferable.

Examples of the lithiumamide compound include lithium hexamethyleneimide, lithium pyrrolidide, lithium peperidide, lithium heptamethyleneimide, lithium dodecamethyleneimide, lithium dimethylamide, lithium diethylamide, lithium dipropylamide, lithium dibutylamide, lithium dihexylamide, lithium diheptylamide, lithium dioctylamide, lithium di-2-ethylhexylamide, lithium didecylamide, lithium-N-methylpiperazide, lithium ethylpropylamide, lithium ethylbutylamide, lithium methylbutylamide, lithium ethylbenzylamide, lithium methylphenethylamide, and the like. Among these examples, a cyclic lithiumamide compound such as lithium hexamethyleneimide, lithium pyrrolidide, lithium peperidide, lithium heptamethyleneimide, lithium dodecamethyleneimide is preferable, and lithium hexamethyleneimide, lithium pyrrolidide are particularly preferable.

Regarding the aforementioned lithiumamide compound, use of a lithiumamide compound represented by formula: Li-AM (in the formula, AM represents the substituted amino group of formula (IV) or the cyclic amino group of formula (V) above) results in production of modified conjugated diene-based polymer having at least one type of nitrogen-containing functional group selected from the group consisting of the substituted amino group represented by formula (IV) and the cyclic amino group represented by formula (V) introduced thereto. For example, in a case where lithium hexamethyleneimide is used, there is obtained a modified conjugated diene-based polymer having at least one hexamethyleneimino group introduced thereto.

In formula (IV) above, R¹ each independently represents C₁₋₁₂ alkyl group, cycloalkyl group or aralykyl group and preferable, specific examples thereof include methyl, ethyl, butyl, octyl, cyclohexyl, 3-phenyl-1-propyl, isobutyl groups, and the like. R¹s may be the same or different from each other. In formula (V), R² represents one of alkylene group having 3 to 16 methylene groups, substituted alkylene group, oxyalkylene group and N-alkylamino-alkylene group. In the present embodiment, examples of the substituted alkylene group include an alkylene group having 1 to 8 substituted sites or substitution groups. Examples of the substitution group include C₁₋₁₂ normal or branched alkyl group, cycloalkyl group, bicycloalkyl group, aryl group and aralykyl group. Preferable, specific examples of R² include trimethylene group, tetramethylene group, hexamethylene group, oxydiethylene group, N-alkylazadiethylene group, dodecamethylene group, hexadecamethylene group, and the like.

There is no particular restriction on the method of producing conjugated diene-based polymer by using the aforementioned polymerization initiator. Polymer can be produced, for example, by carrying out polymerization of monomers in a hydrocarbon solvent which is inactive to the polymerization reaction. In the present embodiment, examples of the hydrocarbon solvent which is inactive to the polymerization reaction include propane, n-butane, isobutene, n-pentane, isopentane, n-hexane, cyclohexane, propene, 1-butene, isobutene, trans-2-butene, cis-2-butene, 1-pentene, 2-pentene, 1-hexane, 2-hexane, benzene, toluene, xylene, ethylbenzene, and the like. These solvents may be used either solely by one type or in combination of two or more types. The aforementioned polymerization reaction may be carried out under the presence of a randomizer. The aforementioned polymerization reaction is preferably carried out by solution polymerization. A concentration of the aforementioned monomer in a polymerization reaction solution is preferably in the range of 5 to 50 mass % and more preferably in the range of 10 to 30 mass %. The method of polymerization if not particularly restricted and polymerization may be carried out either in batch reactors or by continuous polymerization. The reaction temperature during the polymerization reaction is preferably in the range of 0 to 150° C. and more preferably in the range of 20 to 130° C.

In modifying the aforementioned polymerization active sites of polymer by using a modifying agent, preferable examples of the modifying agent for use include a nitrogen-containing compound having a substituted or unsubstituted amino, amido, imino, imidazole, nitrile or pyridyl group. Examples of the nitrogen-containing compound preferable as the modifying agent include isocyanate compound such as diphenylmethane diisocyanate, crude MDI, trimethylhexamethylene diisocyanate, tolylene diisocyanate; and 4-(dimethylamino)benzophenone, 4-(diethylamino)benzophenone, 4-dimethylaminobenzylideneaniline, 4-dimethylaminobenzylidenebutylamine, dimethylimidazolidinone, n-methylpyrrolidone, and the like.

Further, in a case where a coupling agent is used as a modifying agent when polymerization active sites of polymer, obtained by polymerization initiated by a polymerization initiator having a nitrogen-containing functional group, is modified by the modifying agent, plural nitrogen-containing functional groups are introduced into molecules of the modified conjugated diene-based polymer thus obtained, whereby dispersibility of carbon black is remarkably improved. Specifically, preferable examples of the coupling agent include SnCl₄, R³SnCl₃, R³₂SnCl₂, R³₃SnCl, SiCl₄, R³SiCl₃, R³₂SiCl₂, R³₃SiCl, and the like. Specific, preferable examples of R³ include methyl, ethyl, n-butyl, neophyl, cyclohexyl, n-octyl, 2-ethylhexyl groups, and the like. SnCl₄ and SiCl₄ are particularly preferable as the coupling agent.

The modifying reaction of polymerization active sites by the modifying agent is preferably carried out as a reaction in a solution, and monomers used in polymerization may remain in the solution. The reaction type of the modifying reaction is not particularly restricted and the modifying reaction may be carried out either in batch reactors or by continuous polymerization. Further, there is no particular restriction on the reaction temperature during the modifying reaction as long as the reaction proceeds, and the reaction temperature during the polymerization reaction may be continually maintained. The content of the modifying agent in use is preferably in the range of 0.25 to 3.0 mol and more preferably in the range of 0.5 to 1.5 mol per 1 mol of the polymerization initiator used in production of the polymer.

In the rubber composition for tread of the present invention, the natural rubber, which is inherently excellent in elasticity, workability, fracture characteristics, low heat generation properties and the like and suitable for application to tread rubber, can be used as a rubber component thereof. However, depending on the production method of natural rubber, non-rubber components existing in natural rubber latex may adversely affect the inherent physical properties of natural rubber. In view of this, examples of the natural rubber suitably used for the rubber composition for tread of the present invention include natural rubber obtained from latex resulting from partial deproteinization of protein in natural rubber latex by mechanical separation techniques and having the total nitrogen content therein in the range of 0.1 mass % to 0.4 mass % (exclusive of 0.1 mass % and inclusive of 0.4 mass %). The total nitrogen content as an index of protein content, of such natural rubber as described above, is adjusted within the aforementioned range by obtaining the natural rubber by removing proteins existing in natural rubber latex by mechanical means such as centrifugal separation without using chemical means such as a process with enzymes. As a result, low heat generation properties of the rubber composition can be improved without adversely affecting the physical properties which natural rubber inherently possesses.

The natural rubber suitable for the rubber composition for tread of the present invention is produced by, for example, subjecting latex prior to coagulation to partial deproteinization by a mechanical separation technique, preferably centrifugal separation and concentration, such that the total nitrogen content of solid rubber components thereof is within a specific range. If deproteinization is carried out by a technique other than a mechanical separation, effective components having antioxidant effects such as tocotrienol are lost at the same time, although proteins in the solid rubber decreases, whereby aging resistance which natural rubber naturally has may deteriorate.

The total nitrogen content of the natural rubber suitable for the rubber composition for tread of the present invention can be controlled by, for example, adjusting the centrifugal separation conditions (e.g. rotation number, time) for natural rubber latex as a raw material. In a case where the total nitrogen content of the natural rubber is not larger than 0.1 mass %, heat aging resistance of the natural rubber may deteriorate. In a case where the total nitrogen content of the natural rubber exceeds 0.4 mass %, the heat generation-reducing may not be sufficiently obtained.

The natural rubber suitable for the rubber composition for tread of the present invention can be obtained by subjecting natural rubber latex to partial deproteinization, coagulation and drying in this order. The type of natural rubber latex as the raw material is not particularly restricted and field latex and/or commercial latex can be used.

The rubber components of the rubber composition for tread of the present invention essentially include the modified conjugated diene-based polymer. The content of the modified conjugated diene-based polymer in the rubber components is preferably in the range of 10 to 50 mass %. In a case where the rubber components of the rubber composition for tread of the present invention include natural rubber and the modified conjugated diene-based polymer, the total content of the natural rubber and the modified conjugated diene-based polymer are preferably at least 70 mass %. In a case where the content of the modified conjugated diene-based polymer in the rubber components is less than 10 mass %, the carbon black dispersibility improving effect may not be sufficient. In a case where the content of the modified conjugated diene-based polymer in the rubber components exceeds 50 mass %, workability of the rubber composition may deteriorate. In the present embodiment, rubber components generally used in the rubber industries may be optionally blended in a case where the rubber components of the rubber composition for tread is to include a rubber component other than natural rubber and the modified conjugated diene-based polymer.

In the rubber components of the rubber composition for tread of the present invention, the mass ratio (A/B) of natural rubber (A) with respect to the modified conjugated diene-based polymer (B) is preferably in the range of 90/10 to 50/50 and more preferably in the range of 80/20 to 50/50. In the present embodiment, in a case where the proportion of the modified conjugated diene-based polymer to the total of natural rubber and the modified conjugated diene-based polymer is less than 10 mass % (i.e. the proportion of natural rubber exceeds 90 mass %), dispersibility of carbon black is not sufficiently improved, whereby the hysteresis loss-lowering effect may not be sufficiently obtained. In a case where the proportion of the modified conjugated diene-based polymer to the total of natural rubber and the modified conjugated diene-based polymer exceeds 50 mass % (i.e. the proportion of natural rubber is less than 50 mass %), tear resistance may not be sufficient and workability deteriorates.

The carbon black for use in the rubber composition for tread of the present invention preferably has: dibutylphthalate (DBP) absorption in the range of 40 to 180 cm³/100 g; a specific surface area by nitrogen adsorption (N₂SA) in the range of 40 to 300 m²/g; tinting strength (TINT) in the range of 50 to 150%; and light transmittance of toluene extract of not lower than 90%, wherein the values of the specific surface area by nitrogen adsorption (N₂SA) and the light transmittance of toluene extract satisfy the aforementioned formula (III). Carbon black of which DBP absorption, N₂SA, TINT and light transmittance of toluene extract satisfy the aforementioned ranges, respectively, has very small amount of tar contents present on surfaces thereof, thereby remarkably improving wear resistance and low heat generation properties of the rubber composition in a compatible manner.

The carbon black for use in the rubber composition for tread of the present invention exhibits dibutylphthalate (DBP) absorption preferably in the range of 40 to 180 cm³/100 g and more preferably in the range of 70 to 170 cm³/100 g. In a case where the DBP absorption of carbon black is less than 40 cm³/100 g, the tensile stress minimally required of a rubber composition for tread may not be realized. In a case where the DBP absorption of carbon black exceeds 180 cm³/100 g, the extension minimally required of a rubber composition for tread may not be reliably obtained.

The carbon black for use in the rubber composition for tread of the present invention exhibits a specific surface area by nitrogen adsorption (N₂SA) preferably in the range of 40 to 300 m²/g, more preferably in the range of 70 to 250 m²/g, and further more preferably in the range of 70 to 170 m²/g. In a case where the N₂SA of carbon black is less than 40 m²/g, the tensile strength minimally required of a rubber composition for tread may not be realized. In a case where the N₂SA of carbon black exceeds 300 m²/g, dispersibility of carbon black in the rubber composition may not be sufficiently ensured, whereby wear resistance of the rubber composition may deteriorate.

The carbon black for use in the rubber composition for tread of the present invention exhibits tinting strength (TINT) preferably in the range of 50 to 150% and more preferably in the range of 90 to 145%. In a case where the TINT is less than 50%, a tire using the rubber composition in tread may not realize sufficient tensile strength and wear resistance required in actual use. In a case where the TINT exceeds 150%, viscosity of the rubber significantly increases and it is difficult to obtain a rubber composition.

The carbon black for use in the rubber composition for tread of the present invention exhibits light transmittance of toluene extract of preferably not lower than 90% and more preferably not lower than 95%. In a case where the light transmittance of toluene extract of carbon black is less than 90%, the amount of tar components (aromatic hydrocarbon, in particular) present on surfaces of the carbon black may increase, whereby the rubber composition cannot be sufficiently reinforced and wear resistance of the rubber composition may deteriorate.

In the carbon black for use in the rubber composition of the present invention, the absolute values of the specific surface area by nitrogen adsorption (N₂SA) and the light transmittance of toluene extract preferably satisfy the aforementioned formula (III), more preferably satisfy formula (VI) below, and

0.0283×A×(100−B)≦20 (VI)

further more preferably satisfy formula (VII) below.

0.0283×A×(100−B)≦8 (VII)

In formula (VI) and formula (VII), A and B are synonymous with those in formula (III). If the left side of formula (III) exceeds 40, the carbon black may contain an increased amount of tar contents, whereby the rubber composition cannot be sufficiently reinforced and wear resistance of the rubber composition may deteriorate.

The aforementioned carbon black is obtained by: preparing a reaction apparatus having a combustion gas generation zone, a reaction zone, and a reaction cease zone provided in series; generating a high temperature combustion gas in the combustion gas generation zone of the reaction apparatus; introducing a raw material into the reaction zone (e.g. introduction by spraying) to form a reaction gas flow containing carbon black; and then rapidly cooling the reaction gas flow in the reaction cease zone by multi-stage rapid cooling medium introduction means to terminate the reaction. This method of producing carbon black will be described in detail hereinafter with reference to the drawing.

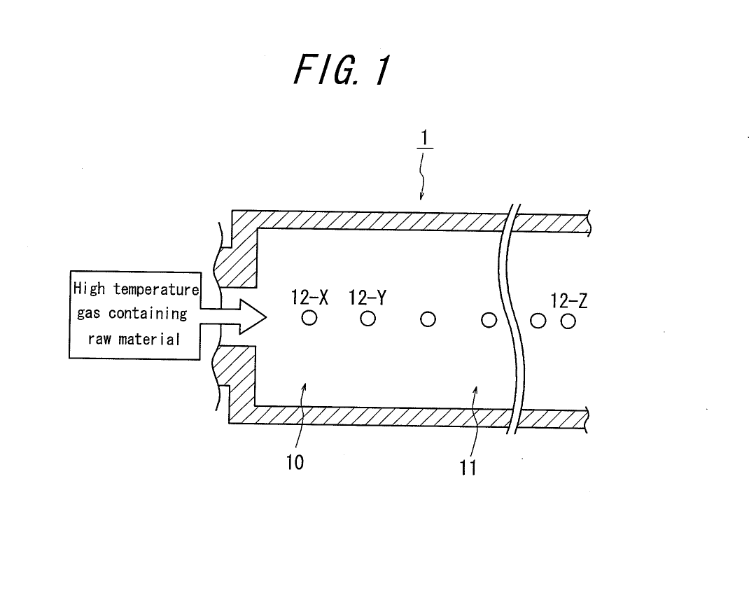

FIG. 1 is a vertically sectional front explanatory view of one example of a carbon black production furnace for producing carbon black for use in a rubber composition of the present invention. The carbon black production furnace 1 has a structure where a combustion zone, a reaction zone, and a reaction cease zone are provided in series inside the furnace and the entire surface of the furnace is covered by a heat resistance material. Specifically, the combustion zone of the carbon black production furnace 1 includes: a combustible fluid introduction chamber; an oxygen-containing gas introduction cylinder for introducing oxygen-containing gas, introduced from the exterior around a head portion of the furnace through an oxygen-containing gas introduction tube, into the combustible fluid introduction chamber by deflecting a flow of the oxygen-containing gas using an air deflecting vane; and a fuel oil spray device or introduction tube provided at the center axis of the oxygen-containing gas introduction cylinder, for introducing hydrocarbon for combustion into the combustible flow introduction chamber. A high temperature combustion gas is generated inside the combustion zone by combustion of hydrocarbon for combustion.

The reaction zone of the carbon black production furnace 1 includes: a converging chamber where the cylinder gradually converges; a raw material oil introduction chamber having four raw material oil spray nozzles provided on the downstream side of the converging chamber; and a reaction chamber 10 on the downstream side of the raw material oil introduction chamber. The raw material oil spray nozzles each introduce by spraying a raw material hydrocarbon into the high temperature combustion gas flow from the combustion zone. That is, the raw material hydrocarbon is introduced by spraying into the high temperature combustion gas flow in the reaction zone, such that the raw material hydrocarbon is changed into carbon black by an incomplete combustion or thermal decomposition reaction.

The reaction cease zone of the carbon black production furnace 1 includes a reaction-continuing and cooling chamber 11 having a multi-stage rapid cooling medium introduction means 12. The multi-stage rapid cooling medium introduction means 12 sprays rapid-cooling medium such as water onto the high temperature combustion gas flow from the reaction zone. That is, the high temperature combustion gas flow is rapidly cooled by the rapid-cooling medium to cease the reaction inside the reaction cease zone. The carbon black production furnace 1 may further include a device for introducing a gaseous material into the reaction zone or the reaction cease zone. In the present embodiment, examples of the “gaseous material” which can be used include mixture of air, oxygen and hydrocarbon, a combustion gas obtained by a combustion reaction of the mixture, and the like. The carbon black for use in the rubber composition of the present invention can be obtained by setting light transmittance of toluene extract of carbon black at respective production stages at desired values by controlling the average reaction temperature and the residence time in the respective zones until the reaction gas flow enters the reaction cease zone in the aforementioned production process of carbon black.

Next, the respective zones in the carbon black production furnace 1 will be described. The combustion zone represents a region where a high temperature gas flow is generated by a reaction between a fuel and air. The downstream-side end of the combustion zone is defined as the position at which the raw material oil is introduced into the reaction apparatus (in a case where the raw material oil is introduced at plural nozzle positions, the most upstream nozzle position among them). The reaction zone represents a region ranging from the position at which the raw material oil is introduced into the reaction apparatus (in a case where the raw material oil is introduced at plural nozzle positions, the most upstream nozzle position among them) to an operating point of the multi-stage rapid cooling water-spraying means 12 in the reaction-continuing and cooling chamber 11 (the means 12 is attachable to/removable from the inside of the reaction-continuing and cooling chamber 11 and the position of the means 12 in use is selected depending on types and characteristics of carbon black to be produced). That is, in a case where the material oil is introduced via a raw material oil spray nozzle and water is introduced via the multi-stage rapid cooling medium introduction means 12, the region between the raw material spray nozzle and the multi-stage rapid cooling medium introduction means 12 presents the reaction zone. The reaction cease zone represents a zone on the downstream side (the right hand-side in FIG. 1) than the operating point of the rapid cooling water pressure-injection and spraying means. In FIG. 1, the appellation of the “reaction-continuing and cooling chamber 11” is used because: the reaction zone represents a region from the introduction point of the raw material to the operating point of the rapid cooling water pressure-injection and spraying means 12 for stopping the reaction; the reaction cease zone represents a region on the downstream side of the reaction zone; and the position of the means 12 may be moved depending on the performances required of carbon black.

The carbon black obtained by the aforementioned production method need to satisfy the relationships shown by formula (I) and formula (II) described above. In FIG. 1, X in formula (I) represents a value of light transmittance of toluene extract (%) of carbon black after introduction of rapid cooling medium from the first rapid-cooling medium introduction means 12-X, and Z in formula (II) represents a value of light transmittance of toluene extract (%) of carbon black after introduction of rapid cooling medium from the last rapid-cooling medium introduction means 12-Z. In the present embodiment, when the carbon black obtained by the aforementioned production method satisfies the relationships of formula (I) and formula (II) above, i.e. when values of light transmittance of toluene extract of the carbon black are specifically adjusted in a stepwise manner, good balance between particle diameter and physical properties of surfaces, of carbon black, can be achieved, whereby reinforcing properties of the carbon black and wear resistance of the rubber composition can be improved.

As described above, carbon black having such characteristics as described above can be obtained by controlling the reaction temperature and the residence time in the respective zones. For example, given that a residence time in a sub-region ranging from spray-introduction of a raw material into the reaction zone to first introduction of the rapid-cooling medium is t₁ (second); the average reaction temperature in this sub-region is T₁ (° C.); a residence time in a sub-region ranging from the first introduction of the rapid-cooling medium to introduction of the rapid-cooling medium by the second rapid-cooling medium introduction means (12-Y in FIG. 1) is t₂ (second); the average reaction temperature in this sub-region is T₂ (° C.); a residence time in a sub-region ranging from the second introduction of the rapid-cooling medium to the last introduction of the rapid-cooling medium (i.e. a residence time in a zone from the second introduction of the rapid-cooling medium to the entry into the reaction cease zone) is t₃ (second); and the average reaction temperature in the sub-region is T₃(° C.), carbon black having a sufficiently small amount of tar contents existing on surfaces thereof can be reliably obtained by controlling these residence times and the average reaction temperatures such that they satisfy formula (VIII), formula (IX) and formula (X) below.

2.00≦α1≦5.00 (VIII)

5.00≦α2≦9.00 (IX)

−2.5×(α1+α2)+85.0≦β≦90.0 (X)

(In the formulae, α1=t₁×T₁, α2=t₂×T₂, β=t₃×T₃)

The carbon black production furnace 1 has a structure which allows thermocouples to be inserted into the furnace at a few desired positions to monitor the temperature inside the furnace. It is preferable to measure temperature at least two, preferably 3 to 4 positions in respective processes (i.e. the respective zones) to calculate the average reaction temperatures T₁, T₂ and T₃. The residence times t₁, t₂ and t₃ are calculated by first calculating a volume of the introduced reaction gas fluid by the known thermodynamic calculation method and then applying it to the equation below. The decomposition reaction of the raw material oil and an increase in volume caused by the rapid-cooling medium are ignored in the calculation.
Residence time t₁ (sec)=(Flow passing volume inside the reaction furnace (m³) from the introduction position of the raw material hydrocarbon to the first introduction position of the rapid-cooling medium)/Volume of the reaction gas fluid (m³/sec);
Residence time t₂(sec)=(Flow passing volume inside the reaction furnace (m³) from the first introduction position of the rapid-cooling medium to the second introduction position of the rapid-cooling medium)/Volume of the reaction gas fluid (m³/sec); and
Residence time t₃(sec)=(Flow passing volume inside the reaction furnace (m³) from the second introduction position of the rapid-cooling medium to the last introduction position of the rapid-cooling medium)/Volume of the reaction gas fluid (m³/sec).

In the rubber composition for tread of the present invention, the content of the carbon black therein is preferably at least 40 parts by mass, and more preferably in the range of 40 to 55 parts by mass, with respect to 100 parts by mass of the rubber components. In a case where the content of carbon black blended in the rubber composition is less than 40 parts by mass with respect to 100 parts by mass of the rubber components, sufficient reinforcement of the rubber composition cannot be ensured. In a case where the content of carbon black blended in the rubber composition exceeds 55 parts by mass with respect to 100 parts by mass of the rubber components, dispersibility of carbon black deteriorates and thus wear resistance, tear resistance and low heat generation properties of the rubber composition may deteriorate. However, in a case where the content of carbon black blended in the rubber composition is less than 40 parts by mass with respect to 100 parts by mass of the rubber components, sufficient reinforcement of the rubber composition (i.e. sufficient wear resistance thereof) can be ensured and hysteresis loss of the rubber composition can be remarkably lowered, by further blending silica in the rubber composition by not more than 20 parts by mass, preferably 3 to 15 parts by mass, with respect to 100 parts by mass of the rubber components. That is, low hysteresis loss and sufficient reinforcement (sufficient wear resistance) of the rubber composition can be achieved in a compatible manner. Examples of silica include wet silica (hydrated silicon oxide), dry silica (anhydrous silicon oxide), colloidal silica, and the like, with no particular restriction thereto.

In a case where silica is blended in the rubber composition for tread of the present invention, a silane coupling agent is preferably added in order to strengthen bonding between silica and rubber components, i.e. to enhance reinforcement or wear resistance of the rubber composition, and improve dispersibility of silica. In the rubber composition for tread of the present invention, the content of the silane coupling therein is preferably less than 10 mass %, more preferably in the range of 5 to 10 mass %, with respect to the content of silica blended with the rubber composition. In a case where the content of silane coupling agent exceeds 10 mass % with respect to the content of silica, the effects of improving wear resistance and dipersibility of the rubber composition reach the plateau state and the blending cost unnecessarily increases. Examples of the silane coupling agent include bis(3-triethoxysilylpropyl)tetrasulfide, 3-trimethoxysilylpropylbenzothiazole tetrasulfide, and the like, with no particular restriction thereto.

The rubber composition for tread of the present invention may further contain a hydrazide compound. The hydrazide compound which may be used for the rubber composition for tread of the present invention can remarkably improve tear resistance of the rubber composition by effecting crosslinking between itself and the main chain portion and the like of the rubber components. In the present embodiment, the content of the hydrazide compound blended in the rubber composition is preferably in the range of 0.5 to 2 pass by mass with respect to 100 parts by mass of the rubber components. In a case where the content of the hydrazide compound is less than 0.5 parts by mass with respect to 100 parts by mass of the rubber components, sufficient tear resistance cannot be obtained. In a case where the content of the hydrazide compound exceeds 2 parts by mass with respect to 100 parts by mass of the rubber components, low heat generation properties of the rubber composition may deteriorate.

As the hydrazide compound, naphthoic acid hydrazide and salicylic acid hydrazide are preferable and specific examples thereof include: napthoic acid hydrazides such as 1-hydroxy-N′-(1-methylethylidene)-2-naphthoic acid hydrazide, 1-hydroxy-N′-(1-methylpropylidene)-2-naphthoic acid hydrazide, 1-hydroxy-N′-(1-methylbutylidene)-2-naphthoic acid hydrazide, 1-hydroxy-N′-(1,3-dimethylbutylidene)-2-naphthoic acid hydrazide, 1-hydroxy-N′-(2,6-dimethyl-4-heptylidene)-2-naphthoic acid hydrazide, 3-hydroxy-N′-(1-methylethylidene)-2-naphthoic acid hydrazide, 3-hydroxy-N′-(1-methylpropylidene)-2-naphthoic acid hydrazide, 3-hydroxy-N′-(1-methylbutylidene)-2-naphthoic acid hydrazide, 3-hydroxy-N′-(1,3-dimethylbutylidene)-2-naphthoic acid hydrazide, 3-hydroxy-N′-(2,6-dimethyl-4-heptylidene)-2-naphthoic acid hydrazide, 3-hydroxy-N′-(1,2-diphenylethylidene)-2-naphthoic acid hydrazide; and salicylic acid hydrazides such as N′-(1-methylethylidene)-salicylic acid hydrazide, N′-(1-methylpropylidene)-salicylic acid hydrazide, N′-(1-methylbutylidene)-salicylic acid hydrazide, N′-(1,3-dimethylbutylidene)-salicylic acid hydrazide, N′-(2,6-dimethyl-4-heptylidene)-salicylic acid hydrazide. The hydrazide compounds may be used either solely by one type or in combination of two or more types.

Additives conventionally used in rubber industries such as softener, anti-oxidant, vulcanization accelerator, vulcanization accelerator auxiliary, vulcanizing agent, and the like may be appropriately selected and blended in the rubber composition for tread of the present invention in addition to the rubber components including the modified conjugated diene-based polymer, the aforementioned carbon black, silica, the silica coupling agent and the hydrazide compound, unless addition of the additives adversely affects the object of the present invention. Commercially available products can be suitably used as these additives. The rubber composition for tread of the present invention can be produced by blending the rubber components with the aforementioned carbon black and additives of various types appropriately selected according to necessity and then subjecting the mixture to kneading, warming, extrusion, and the like.

The tire of the present invention is characterized in that it uses as tread rubber the aforementioned rubber composition for tread, and particularly suitable for a tire for heavy load. The tire of the present invention exhibits well-balanced wear resistance, tear resistance and rolling resistance because the tire uses as tread rubber the aforementioned rubber composition. There is no particular restriction on the present tire, as long as the aforementioned rubber composition is to be used in tread thereof, and the present tire can be produced by the conventional method. Examples of gas to be charged in the tire include ambient air, oxygen partial pressure-adjusted air, and inert gas such as nitrogen, argon, helium and the like.

### EXAMPLES

The present invention will be described in detail hereinafter by Examples. The present invention is not restricted to these Examples.

### Production Example of Modified Polybutadiene Rubber (HMI-BR)

A dry, nitrogen-flushed, approximately 900 mL pressure-resistant glass vessel is charged with 283 g of cyclohexane, 50 g of 1,3-butadiene, 0.0057 mmol of 2,2-ditetrahydrofurylpropane and 0.513 mmol of hexamethyleneimine. Further, 0.57 mmol of n-butyllithium (BuLi) is added to the mixture. Polymerization is then carried out in a warm bath provided with a stirrer at 50° C. for 4.5 hours. The conversion rate in the polymerization is substantially 100%. Next, 0.100 mmol of tin tetrachloride as a modifying agent (a coupling agent) is quickly added to this polymerization reaction system and a modification reaction is allowed to proceed with stirring at 50° C. for 30 minutes. Thereafter, 0.5 mL of 2,6-di-t-butyl-p-cresol (BHT) isopropanol solution (BHT concentration: 5 mass %) is added to the polymerization reaction system to cease the reaction. A drying process is carried out according to the conventional method, whereby modified polybutadiene rubber (HMI-BR) is obtained. In the HMI-BR thus obtained, the content of vinyl bonding in the butadiene portion is 14%, the glass transition temperature (Tg) is −95° C., and the coupling efficiency is 65%.

Regarding HMI-BR thus obtained, the content of vinyl bonding in the butadiene portion is calculated from integration ratios of ¹H-NMR spectrum; the coupling rate is calculated based on a proportion of the peak area located on the largest molecular weight side, to the entire area of the molecular weight distribution curve obtained from the results of gel permeation chromatography (GPC); and the glass transition temperature is calculated from the inflection point in the curve of DSC.

### Production Example of Natural Rubber (PNR) Resulting from Partial Deproteinization

Natural rubber latex (CT-1) to which 0.4 mass % ammonium has been added is concentrated by 15-minute centrifugal separation at 7500 rpm using a latex separator “SLP-3000” manufactured by Saito Separator Ltd. The concentrated latex is further subjected to centrifugal separation for 15 minutes at 7500 rpm. The concentrated latex thus obtained is diluted such that the latex as the solid component is approximately 20% of the solution. Formic acid is added to the latex solution and the mixture is left overnight. The rubber component obtained by coagulation of the mixture is dried at 110° C. for 210 minutes, whereby partially-deproteinized PNR is produced. The total nitrogen content of PNR thus obtained, measured by Kjeldahl method, is 0.15 mass %.

### Production Example of Carbon Black

Carbon black is produced by using the carbon black production furnace 1 as shown in FIG. 1. In the present example, a three-stage rapid-cooling medium introduction means including a first rapid-cooling medium introduction means 12-X, a second rapid-cooling medium introduction means 12-Y, and the last rapid-cooling medium introduction means 12-Z is used as the multi-stage rapid-cooling medium introduction means 12. Further, the carbon black production furnace 1 in use has a structure which allows thermocouples to be inserted into the furnace at a few desired positions to monitor the temperature inside the furnace. In the carbon black production furnace, A-type heavy oil having specific gravity of 0.8622 (15° C./4° C.) is used as the fuel and a heavy oil having characteristics as shown in Table 1 is used as the raw material oil. Carbon blacks A to C having physical properties as described below are produced by setting the operation conditions of the carbon black production furnace as shown in Table 2, respectively.

For each of the carbon blacks thus obtained, dibutylphthalate (DBP) absorption is measured according to ASTM D2414-88 (JIS K6217-97); a specific surface area by nitrogen adsorption (N₂SA) is measured according to ASTM D3037-88; tinting strength (TINT) is measured according to ASTM D3265-88; and light transmittance of toluene extract is measured according to JIS K6218-97.

TABLE 1

| Specific gravity (JIS K2249) (15/4° C.) | | 1.1319 |
|---|---|---|
| Kinematic viscosity at 50° C. (JIS K2283) (mm²/s) | | 26.7 |
| Moisture (JIS K2275) (%) | | 0.5 |
| Carbon residue (JIS K2210) (%) | | 11.6 |
| Sulfur content (JIS K2213) (%) | | 0.4 |
| Carbon content (%) | | 90.1 |
| Hydrogen content (%) | | 5.4 |
| BMCL *1 | | 160 |
| Distillation characteristics | I.B.P. *2 | 188 |
| (° C.) | 10% distillation fraction point | 234 |
| | 30% distillation fraction point | 291 |
| | 50% distillation fraction point | 360 |

*1 BMCL: Bureau of Minos Correlation Index
*2 I.B.P.: Initial Boiling Point

TABLE 2

| | | Carbon | Carbon | Carbon |
|---|---|---|---|---|
| | | black A | black B | black C |
| Conditions of raw material | Introduction rate | 214 | 212 | 218 |
| oil introduction | (kg/hr) | | | |
| | Preheating temperature | 220 | 220 | 213 |
| | (° C.) | | | |
| Conditions of air | Total air introduction | 1188 | 1157 | 1021 |
| introduction | rate (kg/hr) | | | |
| | Preheating temperature | 615 | 606 | 612 |
| | (° C.) | | | |
| | Fuel introduction rate | 58 | 55 | 50 |
| | (kg/hr) | | | |

| | | | |
|---|---|---|---|
| Residence time t₁ (sec) | 0.0018 | 0.0023 | 0.0028 |
| Residence time t₂ (sec) | 0.0045 | 0.0057 | 0.0056 |
| Residence time t₃ (sec) | 0.072 | 0.07 | 0.073 |
| Average reaction temperature T₁ (° C.) | 1574 | 1574 | 1486 |
| Average reaction temperature T₂ (° C.) | 1169 | 1153 | 1238 |
| Average reaction temperature T₃ (° C.) | 1069 | 1078 | 1177 |
| α1 = t₁ × T₁ (sec · ° C.) | 2.83 | 3.62 | 4.16 |
| α2 = t₂ × T₂ (sec · ° C.) | 5.26 | 6.57 | 6.93 |
| β = t₃ × T₃ (sec · ° C.) | 76.97 | 75.46 | 85.92 |
| X (light transmittance of toluene extract, %) | 23 | 31.7 | 29.1 |
| Z (light transmittance of toluene extract, %) | 89.3 | 94.3 | 90.9 |
| DBP absorption (cm³/100 g) | 173 | 173 | 160 |
| N₂SA (m²/g) | 102 | 102 | 94.3 |
| TINT (%) | 108 | 108 | 99.9 |
| Left side of formula (III): 0.0283 × A × (100 − B) | 30.89 | 16.45 | 24.29 |

Next, each of respective rubber compositions having blending prescriptions shown in Tables 3-6 was prepared according to the conventional method by using the modified polybutadiene rubber, the partially-deproteinized natural rubber and the carbon black described above. A test tire for heavy load of size: 11R 22.5 was prepared according to the conventional method by applying the rubber composition to tread rubber. Rolling resistance, wear resistance and tear resistance were evaluated by the methods described below, respectively. The results are shown in Tables 3 to 6.

(1) Rolling Resistance

Rolling resistance of each test tire at 80 km/h is measured under the normal, prescribed load and inner pressure. In Tables 3 and 4, rolling resistance values are expressed by indices with respect to the rolling resistance value of Comparative Example 1-1 being 100. In Tables 5 and 6, rolling resistance values are expressed by indices with respect to the rolling resistance value of Comparative Example 2-1 being 100. The smaller index value represents the smaller rolling resistance.

(2) Wear Resistance

An amount of wear of each test tire, after the tire has run 100,000 km in a state where it is mounted on a drive shaft of a truck, is measured. In Tables 3 and 4, wear resistance values are expressed by indices which are obtained first by converting the original data values to reciprocals thereof and reconverting the reciprocals to said indices with respect to the reciprocal value of Comparative Example 1-1 being 100. In Tables 5 and 6, wear resistance values are expressed by indices which are obtained first by converting the original data values to reciprocals thereof and reconverting the reciprocals to said indices with respect to the reciprocal value of Comparative Example 2-1 being 100. The larger index value represents the smaller wear amount and thus good wear resistance.

(3) Tear Resistance

The total length of tear in each test tire, observed after the tire has run 100,000 km in a state where it is mounted on a drive shaft of a truck, is measured. In Tables 3 and 4, tear resistance values are expressed by indices which are obtained first by converting the original data values to reciprocals thereof and reconverting the reciprocals to said indices with respect to the reciprocal value of Comparative Example 1-1 being 100. In Tables 5 and 6, tear resistance values are expressed by indices which are obtained first by converting the original data values to reciprocals thereof and reconverting the reciprocals to said indices with respect to the reciprocal value of Comparative Example 2-1 being 100. The larger index value represents the better tear resistance.

TABLE 3

| | | Comp. | Comp. | Comp. | Comp. | | | | | Ex. |
|---|---|---|---|---|---|---|---|---|---|---|
| | | Ex. 1-1 | Ex. 1-2 | Ex. 1-3 | Ex. 1-4 | Ex. 1-1 | Ex. 1-2 | Ex. 1-3 | Ex. 1-4 | 1-5 |
| Natural rubber *1 | Parts | 50 | 50 | 50 | — | — | — | — | 60 | — |
| PNR *2 | by | — | — | — | 50 | 60 | 80 | 60 | — | 60 |
| Polybutadiene | mass | 50 | — | 50 | — | — | — | — | — | — |
| rubber *3 | | | | | | | | | | |
| HMI-BR *4 | | — | 50 | — | 50 | 40 | 20 | 40 | 40 | 40 |
| Carbon black A | | 45 | 45 | 45 | 45 | — | — | — | — | — |
| Carbon black B | | — | — | — | — | 45 | 45 | 35 | 35 | 25 |
| Silica *5 | | — | — | — | — | — | — | 5 | 5 | 20 |
| Silane Coupling | | — | — | — | — | — | — | 0.5 | 0.5 | 2 |
| agent *6 | | | | | | | | | | |
| BMH *7 | | — | — | 1.5 | 1.5 | — | — | — | — | — |
| Stearic acid | | 2 | 2 | 2 | 2 | 2 | 2 | 2 | 2 | 2 |
| Antioxidant 6C | | 2 | 2 | 2 | 2 | 2 | 2 | 2 | 2 | 2 |
| *8 | | | | | | | | | | |
| Zinc white | | 3.5 | 3.5 | 3.5 | 3.5 | 3.5 | 3.5 | 3.5 | 3.5 | 3.5 |
| Vulcanization | | 1.5 | 1.5 | 1.5 | 1.5 | 1.5 | 1.5 | 1.5 | 1.5 | 1.5 |
| accelerator CZ *9 | | | | | | | | | | |
| Sulfur | | 1.1 | 1.1 | 1.1 | 1.1 | 1.1 | 1.1 | 1.1 | 1.1 | 1.1 |
| Rolling resistance | Indices | 100 | 88 | 101 | 94 | 89 | 93 | 87 | 88 | 88 |
| Wear resistance | | 100 | 100 | 90 | 98 | 130 | 120 | 105 | 105 | 100 |
| Tear resistance | | 100 | 80 | 120 | 100 | 100 | 120 | 105 | 105 | 105 |

TABLE 4

| | | Ex. 1-6 | Ex. 1-7 | Ex. 1-8 | Ex. 1-9 | Ex. 1-10 |
|---|---|---|---|---|---|---|
| Natural rubber *1 | Parts | — | — | — | 60 | — |
| PNR *2 | by mass | 60 | 80 | 60 | — | 60 |
| Polybutadiene rubber *3 | | — | — | — | — | — |
| HMI-BR *4 | | 40 | 20 | 40 | 40 | 40 |
| Carbon black C | | 45 | 45 | 35 | 35 | 25 |
| Silica *5 | | — | — | 5 | 5 | 20 |
| Silane Coupling agent *6 | | — | — | 0.5 | 0.5 | 2 |
| BMH *7 | | — | — | — | — | — |
| Stearic acid | | 2 | 2 | 2 | 2 | 2 |
| Antioxidant 6C *8 | | 2 | 2 | 2 | 2 | 2 |
| Zinc white | | 3.5 | 3.5 | 3.5 | 3.5 | 3.5 |
| Vulcanization accelerator CZ *9 | | 1.5 | 1.5 | 1.5 | 1.5 | 1.5 |
| Sulfur | | 1.1 | 1.1 | 1.1 | 1.1 | 1.1 |
| Rolling resistance | Indices | 77 | 81 | 75 | 76 | 76 |
| Wear resistance | | 126 | 116 | 102 | 102 | 97 |
| Tear resistance | | 110 | 132 | 116 | 116 | 116 |

*1 “RSS#3”
*2 Partially deproteinized natural rubber obtained by the aforementioned production example: the total nitrogen content = 0.15 mass %
*3 “BR01” manufactured by JSR Corporation
*4 Modified polybutadiene rubber obtained by the aforementioned production example
*5 “Nipsil AQ” manufactured by TOSOH SILICA Corporation
*6 “ABC-856” manufactured by Shin-Etsu Chemical Co., Ltd.
*7 BMH (naphthoic acid hydrazide) manufactured by Otsuka Chemical Co., Ltd.
*8 N-(1,3-dimethylbutyl)-N′-phenyl-p-phenylenediamine
*9 N-cyclohexyl-2-benzothiazolyl sulfenamide

It is understood from the results shown in Tables 3 and 4 that the tires of Examples 1-1 to 1-10, using the rubber composition obtained by blending carbon black having a relatively small amount of tar components existing on surfaces thereof with rubber components including natural rubber and modified conjugated diene-based polymer, exhibit highly-balanced rolling resistance, wear resistance and tear resistance.

Further, it is understood from comparison of Example 1-3 and Example 1-8 with Example 1-4 and Example 1-9, respectively, that rolling resistance can be reduced without sacrificing wear resistance and tear resistance by using in place of conventional natural rubber a natural rubber subjected to partial deproteinization by mechanical separation techniques and having the total nitrogen content in the range of 0.1 mass % to 0.4 mass % (exclusive of 0.1 mass % and inclusive of 0.4 mass %).

Yet further, it is understood from the results of Examples 1-1 to 1-10 that, when the rubber composition using the aforementioned carbon black, silica and a silane coupling agent in combination is employed, sufficient wear resistance and tear resistance can be reliably obtained and rolling resistance can be remarkably reduced in spite of relatively small total content of blended reinforcing fillers (carbon black and silica).

TABLE 5

| | | Comp. | Comp. | Comp. | Comp. | Ex | Ex. | Ex. | Ex. | Ex. | Ex. | Ex. | Ex. |
|---|---|---|---|---|---|---|---|---|---|---|---|---|---|
| | | Ex. 2-1 | Ex.-2 | Ex. 2-3 | Ex. 2-4 | 2-1 | 2-2 | 2-3 | 2-4 | 2-5 | 2-6 | 2-7 | 2-8 |
| Natural | Parts | 50 | 50 | 50 | — | — | — | — | 60 | — | — | — | — |
| rubber *11 | by | | | | | | | | | | | | |
| PNR *12 | mass | — | — | — | 50 | 60 | 60 | 80 | — | 60 | 60 | 60 | 70 |
| Polybutadiene | | 50 | — | 50 | — | — | — | — | — | — | — | — | — |
| rubber *13 | | | | | | | | | | | | | |
| HMI-BR *14 | | — | 50 | — | 50 | 40 | 40 | 20 | 40 | 40 | 40 | 40 | 30 |
| Carbon black A | | 45 | 45 | 45 | 45 | — | — | — | — | — | — | — | — |
| Carbon black B | | — | — | — | — | 45 | 40 | 45 | 45 | 45 | 45 | 50 | 50 |
| Hydrazide | | — | — | 1.5 | 1.5 | — | — | — | — | 0.5 | 2 | 1 | 1 |
| compound | | | | | | | | | | | | | |
| *15 | | | | | | | | | | | | | |
| Stearic acid | | 2 | 2 | 2 | 2 | 2 | 2 | 2 | 2 | 2 | 2 | 2 | 2 |
| Antioxidant | | 2 | 2 | 2 | 2 | 2 | 2 | 2 | 2 | 2 | 2 | 2 | 2 |
| 6C *16 | | | | | | | | | | | | | |
| Zinc white | | 3.5 | 3.5 | 3.5 | 3.5 | 3.5 | 3.5 | 3.5 | 3.5 | 3.5 | 3.5 | 3.5 | 3.5 |
| Vulcanization | | 1.5 | 1.5 | 1.5 | 1.5 | 1.5 | 1.5 | 1.5 | 1.5 | 1.5 | 1.5 | 1.5 | 1.1 |
| accelerator | | | | | | | | | | | | | |
| CZ *17 | | | | | | | | | | | | | |
| Sulfur | | 1.1 | 1.1 | 1.1 | 1.1 | 1.1 | 1.1 | 1.1 | 1.1 | 1.1 | 1.1 | 1.1 | 1.1 |
| Rolling | Indices | 100 | 88 | 101 | 94 | 89 | 87 | 93 | 92 | 92 | 96 | 97 | 99 |
| resistance | | | | | | | | | | | | | |
| Wear | | 100 | 100 | 90 | 98 | 130 | 110 | 120 | 130 | 122 | 100 | 135 | 130 |
| resistance | | | | | | | | | | | | | |
| Tear | | 100 | 80 | 120 | 100 | 110 | 115 | 130 | 110 | 130 | 150 | 130 | 140 |
| resistance | | | | | | | | | | | | | |

TABLE 6

| | | Ex | Ex. | Ex. | Ex. | Ex. | Ex. | Ex. | Ex. |
|---|---|---|---|---|---|---|---|---|---|
| | | 2-9 | 2-10 | 2-11 | 2-12 | 2-13 | 2-14 | 2-15 | 2-16 |
| Natural rubber *11 | Parts | — | — | — | 60 | — | — | — | — |
| PNR *12 | by mass | 60 | 60 | 80 | — | 60 | 60 | 60 | 70 |
| Polybutadiene rubber *13 | | — | — | — | — | — | — | — | — |
| HMI-BR *14 | | 40 | 40 | 20 | 40 | 40 | 40 | 40 | 30 |
| Carbon black C | | 45 | 40 | 45 | 45 | 45 | 45 | 50 | 50 |
| Hydrazide compound *15 | | — | — | — | — | 0.5 | 2 | 1 | 1 |
| Stearic acid | | 2 | 2 | 2 | 2 | 2 | 2 | 2 | 2 |
| Antioxidant 6C *16 | | 2 | 2 | 2 | 2 | 2 | 2 | 2 | 2 |
| Zinc white | | 3.5 | 3.5 | 3.5 | 3.5 | 3.5 | 3.5 | 3.5 | 3.5 |
| Vulcanization accelerator CZ *17 | | 1.5 | 1.5 | 1.5 | 1.5 | 1.5 | 1.5 | 1.5 | 1.1 |
| Sulfur | | 1.1 | 1.1 | 1.1 | 1.1 | 1.1 | 1.1 | 1.1 | 1.1 |
| Rolling resistance | Indices | 86 | 84 | 90 | 89 | 89 | 93 | 94 | 96 |
| Wear resistance | | 113 | 96 | 120 | 104 | 106 | 87 | 117 | 113 |
| Tear resistance | | 121 | 127 | 143 | 121 | 143 | 165 | 143 | 154 |

*11 “RSS#3”
*12 Partially deproteinized natural rubber obtained by the aforementioned production example: the total nitrogen content = 0.15 mass %
*13 “BR01” manufactured by JSR Corporation
*14 Modified polybutadiene rubber obtained by the aforementioned production method
*15 BMH (naphthoic acid hydrazide or N-(1,3-dimethylbutylidene)-3-hydroxy-2-naphthohydrazide) manufactured by Otsuka Chemical Co., Ltd.
*16 N-(1,3-dimethylbutyl)-N′-phenyl-p-phenylenediamine
*17 N-cyclohexyl-2-benzothiazolyl sulfenamide

It is understood from the results shown in Tables 5 and 6 that the tires of Examples 2-1 to 2-16, using the rubber composition obtained by blending carbon black having a relatively small amount of tar components existing on surfaces thereof with rubber components including natural rubber and modified conjugated diene-based polymer, exhibit highly-balanced rolling resistance, wear resistance and tear resistance.

Further, it is understood from comparison of Example 2-1 and Example 2-9 with Example 2-4 and Example 2-12, respectively, that rolling resistance can be reduced without sacrificing wear resistance and tear resistance by using in place of conventional natural rubber a natural rubber subjected to partial deproteinization by mechanical separation techniques and having the total nitrogen content in the range of 0.1 mass % to 0.4 mass % (exclusive of 0.1 mass % and inclusive of 0.4 mass %). Yet further, it is understood from comparison of Example 2-5 to Example 2-8 with Example 2-13 to Example 2-16, respectively, that the rubber composition further including the hydrazide compound blended therein can sufficiently improve both rolling resistance and wear resistance and also remarkably improve tear resistance.

### EXPLANATION OF REFERENCE NUMERALS

1 Carbon black production furnace
10 Reaction chamber
11 Reaction-continuing and cooling chamber
12 Multi-stage rapid cooling medium introduction means
12-X First rapid-cooling medium introduction means
12-Y Second rapid-cooling medium introduction means
12-Z Last rapid-cooling medium introduction means

1. A rubber composition for tread, obtained by blending carbon black with rubber components including modified conjugated diene-based polymer having at least one nitrogen-containing functional group, characterized in that
the carbon black is obtained by:
preparing a reaction apparatus having a combustion gas generation zone, a reaction zone, and a reaction cease zone provided in series;
generating a high temperature combustion gas in the combustion gas generation zone of the reaction apparatus;
introducing a raw material into the reaction zone to form a reaction gas flow containing carbon black; and then
rapidly cooling the reaction gas flow in the reaction cease zone by multi-stage rapid cooling medium introduction means to terminate the reaction, and
light transmittance of toluene extract observed at the multi-stage rapid cooling medium introduction means satisfies relationships of formula (I) and formula (II) below.
10<X<40 (I)
90<Z<100 (II)
In the formulae, X represents light transmittance of toluene extract (%) of carbon black after the first rapid cooling medium, counted from the raw material introduction position, is introduced, and Z represents light transmittance of toluene extract (%) of carbon black after the last rapid cooling medium, counted from the raw material introduction position, is introduced.

2. The rubber composition for tread of claim 1, wherein the rubber components further include natural rubber.

3. The rubber composition for tread of claim 1, wherein the carbon black has: dibutylphthalate (DBP) absorption in the range of 40 to 180 cm³/100 g; a specific surface area by nitrogen adsorption (N₂SA) in the range of 40 to 300 m²/g; tinting strength (TINT) in the range of 50 to 150%; and light transmittance of toluene extract of not lower than 90%, and
the values of the specific surface area by nitrogen adsorption (N₂SA) and the light transmittance of toluene extract satisfy formula (III) below,
0.0283×A×(100−B)≦40 (III)
In the formula, A represents specific surface area by nitrogen adsorption (m²/g) and B represents light transmittance of toluene extract (%).

4. The rubber composition for tread of claim 1, wherein the content of the carbon black to be blended is less than 40 parts by mass with respect to 100 parts by mass of the rubber components and the content of silica to be blended is not larger than 20 parts by mass with respect to 100 parts by mass of the rubber components.

5. The rubber composition for tread of claim 4, wherein the rubber composition contains a silane coupling agent by 10 parts by mass or less with respect to silica.

6. The rubber composition for tread of claim 1, wherein the content of the carbon black blended in the rubber composition is at least 40 parts by mass with respect to 100 parts by mass of the rubber components.

7. The rubber composition for tread of claim 1, wherein examples of the nitrogen-containing functional group include substituted or unsubstituted amino group, amide group, imino group, imidazole group, nitrile group and pyridyl group.

8. The rubber composition for tread of claim 7, wherein the nitrogen-containing functional group is selected from the group consisting of a substituted amino group represented by formula (IV) below, 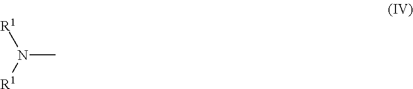
(In the formula, R¹ each independently represents C₁₋₁₂ alkyl group, cycloalkyl group or aralykyl group) and a cyclic amino group represented by formula (V) below, 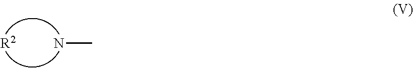
(In the formula, R² represents one of alkylene group having 3 to 16 methylene groups, substituted alkylene group, oxyalkylene group and N-alkylamino-alkylene group).

9. The rubber composition for tread of claim 8, wherein the nitrogen-containing functional group is hexamethyleneimino group.

10. The rubber composition for tread of claim 1, wherein the conjugated diene-based polymer is polybutadiene rubber.

11. The rubber composition for tread of claim 2, wherein the natural rubber is obtained from latex resulting from partial deproteinization of protein in natural rubber latex by mechanical separation techniques, and the total nitrogen content in the natural rubber is in the range of 0.1 mass % to 0.4 mass % (exclusive of 0.1 mass % and inclusive of 0.4 mass %).

12. A tire, characterized in that the tire uses the aforementioned rubber composition for tread of claim 1 as tread rubber.
